(19) United States
(12) Patent Application Publication
(10) Pub. No.: US 2026/0158987 A1
(43) Pub. Date: Jun. 11, 2026

(54) METHODS AND APPARATUS FOR DETERMINING A CORRECTED CURRENT LOAD PITCH ANGLE OF A VEHICLE FOR HEADLAMP BEAM HEIGHT ADJUSTMENT USING A GRAVITATION SENSOR

(71) Applicant: Ford Global Technologies, LLC, Dearborn, MI (US)

(72) Inventors: Matthias Christian Reiter, Aachen (DE); Lars Michael Lottner, Odenthal (DE); Tonny Cloots, Frechen (DE); Uenal Budak, Seeberg (DE)

(21) Appl. No.: 19/188,972

(22) Filed: Apr. 24, 2025

(30) Foreign Application Priority Data
Apr. 29, 2024 (DE) 102024111962.4

(51) Int. Cl. B60Q 1/115; G01C 9/06

(52) U.S. Cl. CPC B60Q 1/115; G01C 9/06; B60Q 2300/132

(57) ABSTRACT

A method for adjustment of a headlamp of a vehicle, the method determines an initial value of a load pitch angle of the vehicle based on output from a gravitation sensor of the vehicle when the vehicle is stationary, determines a change in the load pitch angle, determines a correction parameter of the vehicle based on a chassis behavior of the vehicle, determines a current value of the load pitch angle based on the initial value of the load pitch angle, the change in the load pitch angle, and the correction parameter, and adjusts the headlamp based on the current value of the load pitch angle.

### RELATED APPLICATION

This patent claims priority from DE Patent Application Number 102024111962.4, which was filed on Apr. 29, 2024, and is hereby incorporated herein by reference in its entirety.

### FIELD OF THE DISCLOSURE

The disclosure relates to a method for determining the current load pitch angle of a vehicle for beam adjustment of at least one headlamp of the vehicle. The disclosure also relates to a method and a device for adjusting the beam of at least one headlamp.

### BACKGROUND

The term “pitch angle” refers to the instantaneous angle of the vehicle above the ground. This varies rapidly and is influenced by the load of the vehicle, the vehicle longitudinal dynamics, in particular braking, acceleration, as well as uphill and downhill due to additional power demand, as well as by random road unevenness. As used herein, the factory state or the state of an unladen vehicle is defined as a state with a pitch angle of zero degrees. All other angles describe a deviation from the factory state or from the unladen state.

### SUMMARY

An example method for adjustment of a headlamp of a vehicle includes determining an initial value of a load pitch angle of the vehicle based on output from a gravitation sensor of the vehicle when the vehicle is stationary, determining a change in the load pitch angle, determining a correction parameter of the vehicle based on a chassis behavior of the vehicle, determining a current value of the load pitch angle based on the initial value of the load pitch angle, the change in the load pitch angle, and the correction parameter, and adjusting the headlamp based on the current value of the load pitch angle.

An example non-transitory machine readable storage medium includes instructions to cause programmable circuitry to at least determine an initial value of a load pitch angle of a vehicle based on output from a gravitation sensor of the vehicle when the vehicle is stationary, determine a change in the load pitch angle, determine a correction parameter of the vehicle based on a chassis behavior of the vehicle, determine a current value of the load pitch angle based on the initial value of the load pitch angle, the change in the load pitch angle, and the correction parameter, and control a movement of a headlamp of the vehicle based on the current value of the load pitch angle.

An example apparatus for headlamp adjustment of a vehicle includes a gravitation sensor, machine-readable instructions, and programmable circuitry to execute the machine-readable instructions to determine an initial value of a load pitch angle of the vehicle when the vehicle is stationary based on output from the gravitation sensor of the vehicle, determine a change in the load pitch angle, determine a correction parameter of the vehicle based on a chassis behavior of the vehicle, determine a current value of the load pitch angle based on the initial value of the load pitch angle, the change in the load pitch angle, and the correction parameter, and adjust a position of a headlamp of the vehicle based on the current value of the load pitch angle.

### BRIEF DESCRIPTION OF DRAWINGS

FIG. 1 shows schematically the influence of a vehicle load on the pitch angle of the vehicle.

FIG. 2 shows schematically the principle of determining the pitch angle relative to the direction of gravity via a gravitation sensor.

FIG. 3 shows schematically the influence of a change in the load of a vehicle on the track width and the pitch angle when starting the vehicle.

FIGS. 4-6 are flowcharts representative of example machine-readable instructions and/or example operations that may be executed, instantiated, and/or performed by example programmable circuitry to implement example methods disclosed herein including an headlamp beam height adjustment system.

FIG. 7 shows a schematic diagram of an example motor vehicle with a device according to the teachings herein for beam height adjustment.

FIG. 8 is a block diagram of an example processing platform including programmable circuitry structured to execute, instantiate, and/or perform the example machine readable instructions and/or perform the example operations of FIGS. 4, 5, and 6.

In general, the same reference numbers will be used throughout the drawing(s) and accompanying written description to refer to the same or like parts. The figures are not necessarily to scale.

### DETAILED DESCRIPTION

Headlamp beam height adjustment systems can necessitate a current load pitch angle of a vehicle with respect to a road surface as an input variable. A change in the pitch angle can occur due to a driving style or as a result of loading or unloading of the vehicle(e.g., a car with a loaded trunk). When the load pitch angle changes, the headlamps should be readjusted (e.g., corrected upwards or downwards with respect to their beam angle). For motor vehicles registered in the European Union (EU), beam height adjustment systems are mandatory for certain types of headlamps.

An averaged pitch angle is understood to mean the measuring angle of a system that determines an averaged pitch angle when the vehicle is driving (e.g. a camera that determines a horizon angle via a series of images). The load pitch angle is the quasi-static component of the pitch angle, which depends only on the load and, thus, not on the driving situation. It corresponds to the angle that is set when the vehicle is at a standstill on a horizontal surface. The dynamic pitch angle refers to the current, (e.g., the instantaneous, rapidly varying, deviation of the pitch angle from the load pitch angle), in other words the portion of the pitch angle that depends on the driving situation (e.g., braking, accelerating, uphill, downhill).

In known examples, the pitch angle of a vehicle is typically determined using two mechanical level sensors, with a first level sensor being mounted on a front axle and a second level sensor mounted on a rear axle. The level sensors provide information about a change in a suspension height, wherein an electrical output signal from the level sensor changes depending on the suspension height of the vehicle.

This signal can be used by a control unit (e.g. a headlamp control module (HCM)) to calculate the pitch angle and to control a stepper motor within the headlamp for its adjustment. In combination with knowledge of a wheelbase of the vehicle, a direct, accurate and rapid method for determining the change in the pitch angle of the vehicle, for example due to additional loading or other factors is, thus, available. There are also other variants available that are based on only one level sensor, typically on the rear axle.

However, these sensors are complex to integrate onto existing vehicles. They are also maintenance-intensive, as they are directly exposed to environmental effects such as the weather, and mechanical effects caused by the road surface, in particular possible stone chips. It is therefore desirable to replace the previously described solution based on mechanical sensors with suitable alternatives. A combination of other existing sensors proves particularly useful. While it is possible to determine the load pitch angle using other sensors, typically ones already present in a vehicle, such as acceleration sensors, it is difficult to achieve the required accuracy, however, which allows only small tolerances for lighting requirements.

Known methods can determine an average pitch angle with respect to the road surface via images acquired by a front-facing camera. The average pitch angle is typically determined while the vehicle is driving. Because the vehicle pitch angle can vary depending on driving conditions, for example, in connection with an ascent or descent, the average pitch angle determined by the camera also differs from the pitch angle of the vehicle that occurs when the vehicle comes to a standstill in a horizontal plane (“load pitch angle”). However, a headlamp beam height adjustment system requires this load pitch angle as an input variable.

The documents DE 10 2017 005 019 A1, DE 10 2020 128 440 A1, DE 10 2011 017 697A1 , US2021/0323466 A1 and US2017/0225609 A1 describe methods and devices for adjusting the headlamp beam height using a camera. In document U.S. Pat. No. 10,953,787 B2, various sensors are used in connection with headlamp beam height adjustment. Further prior art is disclosed in documents EP 2 130 718 A2, CN 112477750 B, DE 10 2021 006290 A1,EP 0 709 240 A1, U.S. Pat. Nos. 6,693,380 B2, 6,450,673 B1, 6,193,398 B1, 9,260,051 B2, WO 2023/090327 A1, WO 2023/094452 A1 und U.S. Pat. No. 11,390,207 B2.

Against this background, examples disclosed herein provide advantageous methods for determining the current load pitch angle of a vehicle for headlamp beam height adjustment. Examples disclosed herein provide advantageous methods and apparatus for headlamp beam height adjustment.

Examples described herein provide methods for determining the current load pitch angle of a vehicle, methods for headlamp beam height adjustment, a device for headlamp beam height adjustment, vehicles, computer-implemented methods, computer program products, and a computer-readable media having instructions to be executed by processors.

A part of examples disclosed herein is the observation that, when a vehicle is loaded or unloaded, the track width or the wheelbase and, thus, the position of the headlights generally changes slightly when the vehicle starts moving and the chassis (e.g., the springs and/or suspension) transfers to an unstressed state. During loading or unloading while the vehicle is stationary, the friction between the tires and the road surface degrades or prevents the transition of the chassis (e.g., the suspension, the track width, etc.) to an unstressed or neutral state (e.g., the lateral direction in a wishbone suspension or the longitudinal direction in a trailing arm suspension). As a result, the distance (e.g., the height) of the headlight in relation to the road surface changes slightly when the vehicle starts moving. When the vehicle is loaded, the bodywork drops down and when the vehicle is unloaded, it will rise.

This change may have a significant effect on the beam height. Investigations (e.g., lightning homologation tests) have revealed deviations of up to 15 percent in the beam height due to the described effect. In the case of a transition from a fully unloaded to a fully loaded state of a vehicle, the described effect can add up to an error of 0.2 to 0.25 degrees (e.g., corresponding to approximately 0.4 percent of gradient). Examples described herein address the described effect.

Example methods described herein for determining (e.g., estimating or calculating) the current load pitch angle of a vehicle for beam height adjustment of at least one headlamp (e.g., a front headlamp) of the vehicle relates to a vehicle which includes at least one gravitation sensor.

An example method includes the following operations. When the vehicle is stationary, an initial pitch angle of the vehicle relative to gravity is determined via the gravitation sensor. The initial pitch angle can be determined, for example, in relation to the direction of gravity or a direction perpendicular to the direction of gravity. In a next operation, a change in the current pitch angle of the vehicle relative to gravity compared to the initial pitch angle of the vehicle is determined (e.g., detected or measured). The change in the current pitch angle can be detected or measured in relation to the direction of gravity. The change in the current pitch angle may occur because of a change in the loading state of the vehicle. In this context, a change in the loading state of the vehicle can optionally be detected and used as a reference.

In a further operation, a correction parameter (e.g., an anticipated additional correction parameter in the form of a correction value or correction factor, etc.) for determining the current load pitch angle of the vehicle is determined (e.g., ascertained, calculated, or estimated).

After the correction parameter has been determined (e.g. the anticipated additional correction parameter), the current load pitch angle of the vehicle is determined (e.g., ascertained, calculated, or estimated) based on the determined initial pitch angle relative to gravity, the determined change in the current pitch angle, and the determined correction parameter.

The example method has the advantage that it efficiently considers the above-described influence of the behavior of the chassis on a current load pitch angle determined at standstill in the event of a change in the vehicle loading state at standstill. A change in pitch angle occurring because of a relaxation of the suspension when the vehicle starts is anticipated and considered while the vehicle is still stationary when determining the current load pitch angle. It is, thus, possible to determine the current load pitch angle relatively quickly, accurately, and reliably even when the vehicle is stationary. The example method allows an exact determination of the respective current load pitch angle and is therefore suitable for a reliable determination of the influence of load on the headlamp beam height adjustment.

Example methods disclosed herein have the advantage that a load pitch angle can be determined without the use of the level sensors described above. Therefore, in connection with a headlamp beam height adjustment, the use of level sensors may be omitted in the future. This can reduce overall complexity of the system.

In some examples, the current load pitch angle is determined after the vehicle is restarted if the vehicle has been stationary. This has the advantage that it can be assumed that the loading and/or unloading of the vehicle is completed at this point in time and that the correction parameter (e.g., the correction value to be used) therefore no longer changes (e.g., is fixed).

In some examples, via the determined initial pitch angle relative to gravity and the determined change in the current pitch angle of the vehicle relative to gravity in comparison to the initial pitch angle relative to gravity, an uncorrected current load pitch angle can be determined which is corrected via the determined correction parameter (e.g., in the form of a correction value). Alternatively, the current load pitch angle can also be directly determined from the data collected by the gravitation sensor and the determined correction parameter without explicitly determining an uncorrected current load pitch angle.

The correction parameter for the specific vehicle can be defined individually or for the vehicle type or a group of vehicles or vehicle types, wherein the correction parameter characterizes or represents the behavior of the chassis of the vehicle in the unstressed state (e.g., in a neutral state in which no frictional force occurs between the tire and the road surface that would affect the current track width of the vehicle) as a function of a change in the vehicle loading state and/or as a function of a change in the current pitch angle of the vehicle compared to an initial pitch angle of the vehicle. By customizing or tailoring the correction to groups of vehicles or vehicle types as described, the accuracy of the determination of the current load pitch angle is increased.

For example, a correction value, a correction factor, a mathematical correction function, a correction value lookup table, or a correction value curve can be used as the correction parameter. The use of a global correction value or correction factor provides a solution.

The correction parameter can depend on the determined change in the current pitch angle of the vehicle relative to gravity compared to the initial pitch angle of the vehicle relative to gravity. In other words, the correction parameter can be configured as a parameter or value dependent on the determined change in the current pitch angle of the vehicle in comparison to the initial pitch angle of the vehicle, or a suitably dependent quantity.

As already mentioned, the correction parameter can depend on the determined change in the current pitch angle of the vehicle relative to gravity in comparison to the initial pitch angle of the vehicle relative to gravity, in the form of a factor, a percentage uplift, and/or a functional dependence.

In addition, the correction parameter can depend, or be configured to be dependent, on at least one technical feature of the chassis, the wheel suspension, the springs, and/or the vibration damping of the vehicle. By considering the specific equipment of the individual vehicle, a high accuracy and reliability in the determination of the current load pitch angle can thereby be achieved.

An example method for adjusting the beam height of at least one headlamp (e.g., a front headlamp) of a vehicle includes the following operations. A setting position of the at least one headlamp is determined. The prerequisite for this is an adjustment of the zero angle. Thus, with a nominal basic setting of a stepper motor angle, the headlamp is calibrated as part of the assembly in such a way that a defined light exit gradient is achieved. Normally, the headlamp is set (e.g., by activation) to a “zero position” at the end of the production line. Since the headlamps as a component are subject to large mechanical tolerances, the angle is then corrected via adjusting screws or electronic activation so that the light is emitted at a fixed angle. This process is also known as “adjustment” or “aiming” and provides the setting position as a prerequisite for any further compensation. Subsequent beam height adjustment or “leveling” identifies changes in the angle between the vehicle and the ground and compensates for the fixed light exit angle or the required deviation from the setting position.

Subsequently to the determination of the setting position of the at least one headlamp, the current load pitch angle of the vehicle is determined via an example method described above. In a next or subsequent operation, the deviation of the current load pitch angle of the vehicle from the setting position and, thus, the resulting deviation of the at least one headlamp from the setting position is determined. Further, a new setpoint angle can be defined. The setting, (e.g., the light output angle) of the at least one headlamp is then adjusted according to the determined deviation. For example, the new, defined setpoint angle can be activated. The beam height can be adjusted by mechanically rotating a pivot frame by the required angle (e.g., controlled by a stepper motor). With high-resolution pixel headlights, it is possible to switch pixel rows on or off so that no light is emitted above the desired light-dark limit. In other words, a change in the light output angle is compensated.

The method according to examples disclosed herein has the features and advantages already described in connection with the example methods described above for determining the current load pitch angle of the vehicle.

An example device according to examples described herein for beam height adjustment of at least one headlamp of a vehicle relates to a vehicle which includes at least one gravitation sensor. The example device for beam height adjustment is configured to receive data from the gravitation sensor and to carry out a method for beam height adjustment according to the examples described above. The example device for beam height adjustment has the features and advantages already mentioned in connection with the example methods described above.

An example vehicle includes a device for beam height adjustment described above. The vehicle has the advantages already described. The vehicle can be an electric vehicle or a hybrid electric vehicle (HEV). The vehicle can be a motor vehicle, e.g. a passenger car, a truck, a bus, a minibus, a motorcycle, a moped, etc.

An example computer-implemented method includes commands, which during the execution of the program by a computer cause said computer to carry out a method according to the examples described above. The computer program product includes commands, which during the execution of the program by a computer cause said computer to carry out a method according to the examples described above. The example computer program product is stored on the computer-readable data carrier. The example computer-implemented method, the example computer program product, and the example computer-readable data carrier have the above-mentioned features and advantages.

The disclosure is described hereafter in greater detail on the basis of examples and by reference to the attached drawings. Although the disclosure is illustrated and described in greater detail via the examples, the disclosure is not restricted by the examples disclosed and other variations can be derived therefrom by the person skilled in the art without departing from the scope of the disclosure.

The figures are not necessarily accurate in every detail or true to scale and can be shown enlarged or reduced to provide a better overview. Therefore, functional details disclosed here are not to be understood in a restrictive sense, but merely as a descriptive basis which offers guidance to the person skilled in the art in this field of technology for applying the described examples in a variety of ways.

As used herein, the term “and/or”, when used in a series of two or more elements, means that each of the items listed can either be used alone, or else any combination of two or more of the listed elements can be used. For example, if a combination is described which contains the components A, B and/or C, the combination can contain A alone; B alone; C alone; A and B in combination; A and C in combination; B and C in combination; or A, B, and C in combination.

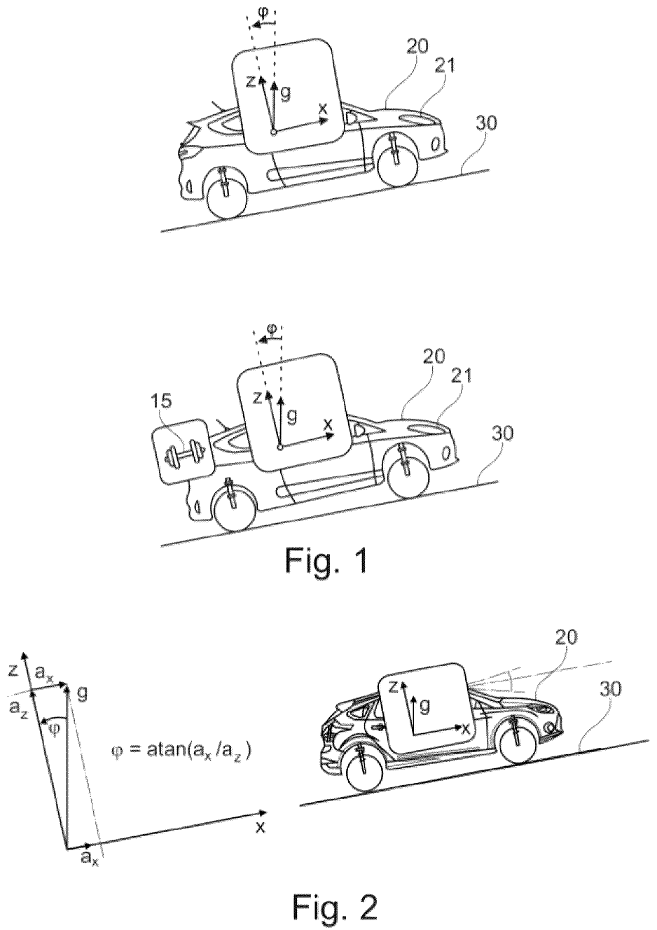

FIG. 1 schematically shows the influence of a load 15 of a vehicle 20 on a pitch angle φ of the vehicle 20 with respect to a direction of gravity g. In FIG. 1, the vehicle 20 is shown in the upper diagram in an unladen state and in the lower diagram in a loaded state, in each case positioned on an inclined road surface 30. The load 15 is represented by a weight. A direction of the acceleration due to gravity g is shown with respect to a longitudinal axis x and a vertical axis z of the vehicle 20. The current pitch angle φ of the vehicle 20 relative to the direction of gravity g is in this case the angle enclosed by the direction of the gravitational acceleration g and the vertical axis z of the vehicle 20. The load 15 increases the pitch angle relative to the gravitational angle φ of the vehicle 20 relative to the direction of gravity g (see FIG. 1 bottom diagram in comparison to top diagram). Known methods use the change in the pitch angle relative to the gravitation angle φ to directly infer a change in the load pitch angle of the vehicle 20 and thus a change in the beam height of headlamps 21 of the vehicle 20 while driving.

FIG. 2 shows schematically the principle of determining the pitch angle relative to gravity via a gravitation sensor 24. In the example shown, the direction of the gravitational acceleration g is determined with respect to a longitudinal axis x and a vertical axis z of the vehicle 20. As shown in the diagram on the left in FIG. 2, this can be carried out by way of an acceleration detected in the z direction a_{z} and an acceleration detected in the x direction aₓ. The pitch angle with respect to gravity φ or the change in the pitch angle with respect to gravity φ can be calculated from this trigonometrically, as shown in FIG. 2 on the left.

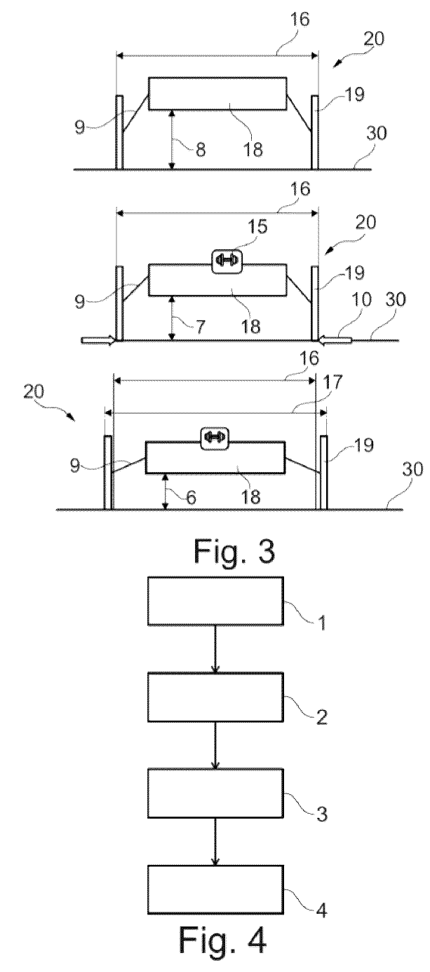

FIG. 3 shows schematically the influence of a change in the load 15 of a vehicle 20 on a track width 16, 17 of the vehicle 20 and consequently on the pitch angle φ when starting the vehicle 20. In FIG. 3, a vehicle body 18, a wheel suspension 9 and wheels 19 of a rear axle of the vehicle 20 are each shown schematically in three operating states shown one below another. In FIG. 3 at the top, the vehicle 20 is at a standstill in the unladen state and has an initial track width 16. The vehicle 20 is then loaded 15 and remains at a standstill. This is shown in the center diagram of FIG. 3. As a result of the frictional force between the wheels 19 and the road surface 30, a tension or lateral force 10 occurs, marked by arrows. The wheel suspension 9, in particular the springs, cannot transfer to a relaxed state and react to the load 15 by adjusting the track width 16.

If the vehicle 20 then starts and moves a few meters, the lateral force 10 no longer acts and the track width 16, 17 adapts itself. This is shown at the bottom of FIG. 3. The track width 17 resulting from the load 15, which is produced after the vehicle is started 20, is greater than the initial track width 16. The increase in the track width causes the bodywork or vehicle body 18 to drop down. The distance of the vehicle body 18 from the road 30 is indicated in FIG. 3 at the top with an arrow 8, in the middle with an arrow 7 and at the bottom with an arrow 6, where the distance 7 is less than the distance 8 and the distance 6 is less than the distance 7. The difference between the distance 6 and the distance 7 has a significant effect on a current load pitch angle determined at standstill in the state of the vehicle 20 shown in the middle of FIG. 3. Examples described herein consider this deviation when determining the current load pitch angle before or immediately upon starting the vehicle 20.

FIG. 4 shows a schematic diagram of an example method for determining the current load pitch angle of a vehicle in the form of a flowchart. In operation 1, a gravitational sensor of the vehicle is used to determine an initial pitch angle of the vehicle when the vehicle is stationary. In operation 2 a change in the current pitch angle of the vehicle compared to the initial pitch angle of the vehicle is determined. In operation 3, a correction parameter to determine the current load pitch angle of the vehicle is determined. In operation 4, the current load pitch angle of the vehicle is determined based on the determined initial pitch angle relative to gravity, the determined change in pitch angle relative to gravity, and the determined correction parameter.

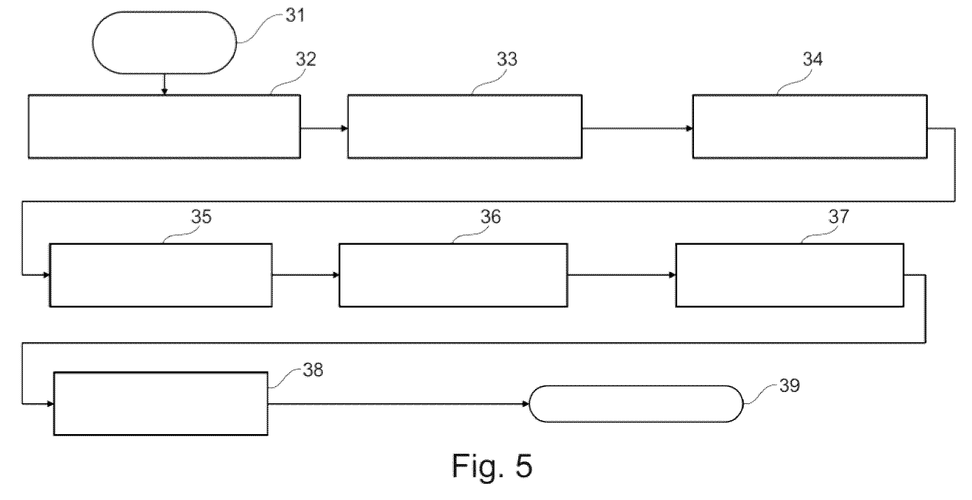

FIG. 5 shows a schematic diagram of an example method for determining the current load pitch angle of a vehicle in the form of a flowchart. In operation 31, the vehicle comes to a standstill or is already at a standstill. In operation 32, the pitch angle of the vehicle relative to the direction of gravity (e.g., the initial pitch angle) is measured and stored. In operation 33 the vehicle is loaded. In operation 34, a change in the pitch angle of the vehicle relative to the direction of gravity is determined (e.g., measured or estimated). In operation 35, an anticipated additional change in the vehicle pitch angle relative to the direction of gravity is calculated as a platform or basis for determining the change in the load pitch angle. In operation 36, a current load pitch angle is estimated or determined based on the change in pitch angle relative to gravity. In operation 37, the vehicle starts moving. In operation 38, the determined (e.g., estimated) current load pitch angle is corrected via the anticipated additional change in the pitch angle of the vehicle. In operation 39, the vehicle drives (e.g., continues its movement).

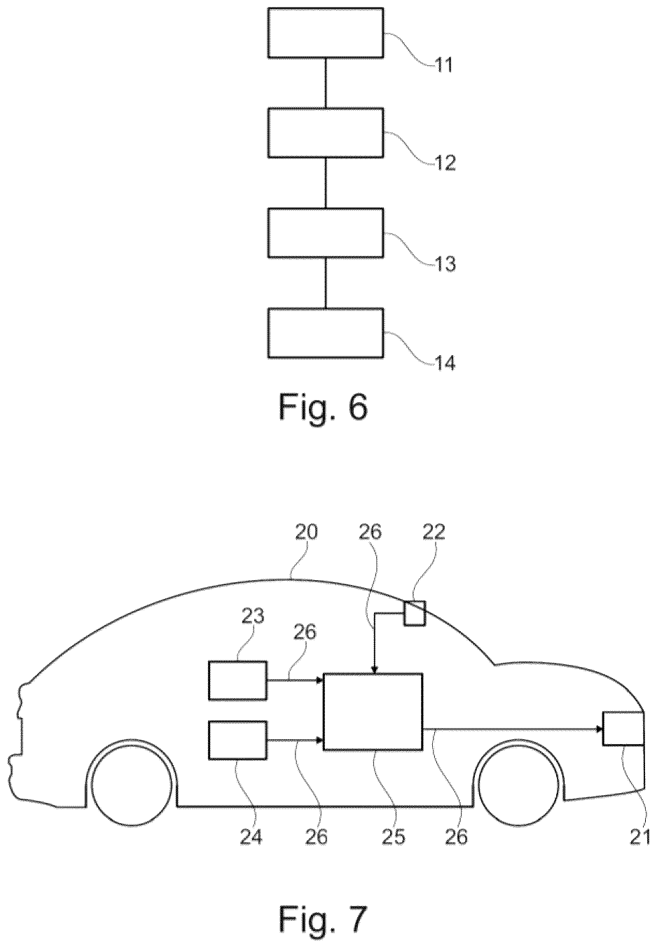

FIG. 6 shows a schematic drawing of an example method for beam height adjustment in the form of a flowchart. In operation 11, a setting position of the at least one headlamp for controlling the beam height is determined. The prerequisite for this is an adjustment of the zero angle. Thus, with a nominal basic setting of a stepper motor angle, the headlamp is calibrated as part of the assembly in such a way that a defined light exit gradient is achieved. This means that the headlamp is mechanically and/or optically calibrated (e.g., headlamp adjustment). In doing so, a zero angle command can be issued to set the beam height, which this also then moves to. At the same time, the corresponding load pitch angle (e.g., reference load angle, zero load angle) can be determined (e.g., in a reference station with known targets).

In operation 12, the current load pitch angle of the vehicle is determined, in particular relative to the zero load angle or to the setting position determined in operation 11, for example via the example methods explained with reference to FIGS. 4 and 5. In operation 13, based on the determined current load pitch angle of the vehicle, the deviation of the current load pitch angle from the setting position is determined and, thus, the resulting deviation of the headlamp from the setting position. In this context, a new setpoint angle can be defined. Then, in operation 14, the setting, in particular the light exit angle of the at least one headlamp, is adjusted according to the determined deviation (e.g., the defined, new target angle is activated).

Example instructions and/or operations of FIGS. 4, 5, and 6 may be implemented using executable instructions (e.g., computer-readable, and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 7 shows a schematic drawing of an example motor vehicle 20 including the device 25 for beam height adjustment. The motor vehicle 20 includes at least one headlamp 21 (e.g., a front headlamp) and at least one gravitation sensor 24. Furthermore, in some examples, the vehicle 20 or the device for headlamp beam height adjustment 25 includes a device for determining acceleration data 23 of the vehicle. In some examples, the vehicle 20 or the device for beam height adjustment 25 can include a device 22 for determining an average pitch angle of the vehicle, in particular an environment detection device 22, for example, implemented as a camera, which may be mounted, in particular, on a windscreen.

The device for beam height adjustment 25 is designed to receive data from the gravitational sensor 24 and optionally the device for determining an average pitch angle of the vehicle 22 and the device for determining acceleration data (e.g., the longitudinal acceleration) 23 of the vehicle 20 and to carry out a example method for beam height adjustment, for example, a method described with reference to FIG. 6. The data transmission is indicated in FIG. 7 by arrows with the reference sign 26. For setting (e.g., controlling or adjusting) the beam height of the headlamp 21, the beam height adjustment device 25 transmits corresponding data to a control unit, for example for controlling a stepper motor within the headlamp 21.

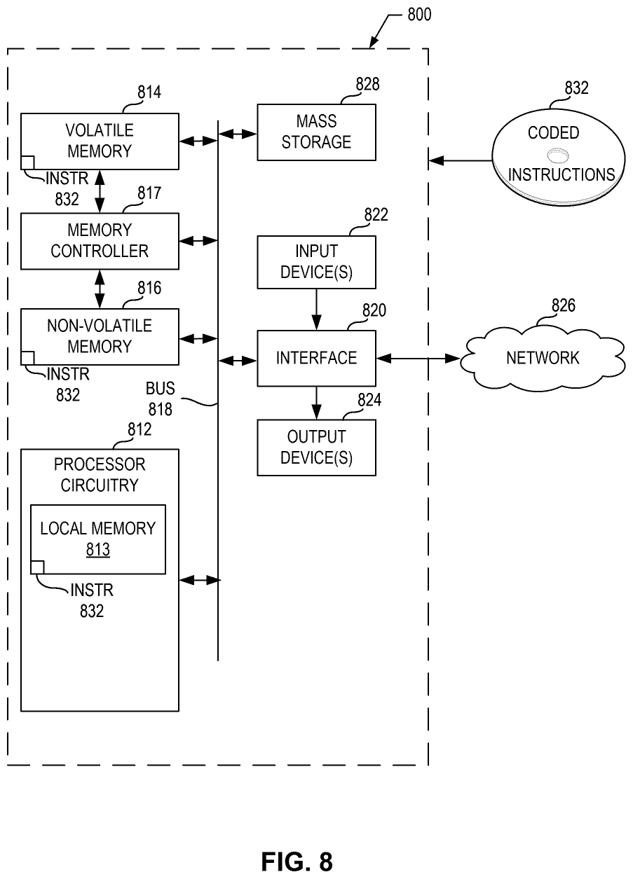

FIG. 8 is a block diagram of an example programmable circuitry platform 800 structured to execute and/or instantiate the example machine-readable instructions and/or the example operations of FIGS. 4, 5, and 6 to implement the device 25 and/or its various components disclosed herein. The programmable circuitry platform 800 can be, for example, a control device, an ECU, a self-learning machine (e.g., a neural network), or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, VPUs, DSPs, and/or microcontrollers from any desired family or manufacturer. The programmable circuitry 812 may be implemented by one or more semiconductor based (e.g., silicon based) devices.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a button, a touchscreen, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 820 of the illustrated example, thus, typically includes a graphics driver card, a graphics driver chip, and/or graphics processor circuitry such as a GPU.

Example methods, apparatus, systems, and articles of manufacture to enable operating electronic steering systems and vehicles with electronic steering systems are disclosed herein. Further examples and combinations thereof include the following:

Example 1 includes a method for adjustment of a headlamp of a vehicle, the method comprising determining an initial value of a load pitch angle of the vehicle based on output from a gravitation sensor of the vehicle when the vehicle is stationary, determining a change in the load pitch angle, determining a correction parameter of the vehicle based on a chassis behavior of the vehicle, determining a current value of the load pitch angle based on the initial value of the load pitch angle, the change in the load pitch angle, and the correction parameter, and adjusting the headlamp based on the current value of the load pitch angle.

Example 2 includes the method according to example 1, wherein the current value of the load pitch angle is determined in response to starting the vehicle.

Example 3 includes the method according to example 1,wherein the current value of the load pitch angle is determined further based on a comparison of the change in the load pitch angle and the initial value of the load pitch angle.

Example 4 includes the method according to example 1, wherein the correction parameter includes at least one of a correction value, a correction factor, a mathematical correction function, a correction value lookup table, or a correction value curve.

Example 5 includes the method according to example 1, wherein the correction parameter corresponds to the change in the load pitch angle relative to the initial value of the load pitch angle.

Example 6 includes the method according to example 5, wherein the correction parameter is expressed as at least one of a factor, a percentage uplift, or a functional dependence.

Example 7 includes the method according to example 1, wherein the correction parameter is determined based on characteristics of at least one of a chassis, a wheel suspension, springs, or vibration damping of the vehicle.

Example 8 includes the method according to example 1, including determining a setting position of the headlamp, determining a deviation of the current value of the load pitch angle from the setting position and a resulting deviation of the headlamp from the setting position, and adjusting the setting position of the headlamp based on the deviation.

Example 9 includes a non-transitory machine readable storage medium comprising instructions to cause programmable circuitry to at least determine an initial value of a load pitch angle of a vehicle based on output from a gravitation sensor of the vehicle when the vehicle is stationary, determine a change in the load pitch angle, determine a correction parameter of the vehicle based on a chassis behavior of the vehicle, determine a current value of the load pitch angle based on the initial value of the load pitch angle, the change in the load pitch angle, and the correction parameter, and control a movement of a headlamp of the vehicle based on the current value of the load pitch angle.

Example 10 includes the non-transitory machine readable storage medium of example 9, wherein the current value of the load pitch angle is determined in response to determining that the vehicle has been started.

Example 11 includes the non-transitory machine readable storage medium of example 9, wherein the current value of the load pitch angle is determined further based on a comparison of the change in the load pitch angle and the initial value of the pitch angle.

Example 12 includes the non-transitory machine readable storage medium of example 9, wherein the correction parameter includes at least one of a correction value, a correction factor, a mathematical correction function, a correction value lookup table, or a correction value curve.

Example 13 includes the non-transitory machine readable storage medium of example 9, wherein the correction parameter corresponds to the change in the load pitch angle relative to the initial value of the load pitch angle.

Example 14 includes the non-transitory machine readable storage medium of example 13, wherein the correction parameter is expressed as at least one of a factor, a percentage uplift, or a functional dependence.

Example 15 includes the non-transitory machine readable storage medium of example 9, wherein the correction parameter is determined based on characteristics of at least one of a chassis, a wheel suspension, springs, or vibration damping of the vehicle.

Example 16 includes the non-transitory machine readable storage medium of example 9, wherein the instructions cause the programmable circuitry to determine a setting position of the headlamp, determine a deviation of the current value of the load pitch angle from the setting position and a resulting deviation of headlamp from the setting position, and adjust the setting position of the headlamp based on the deviation.

Example 17 includes an apparatus for headlamp adjustment of a vehicle, the apparatus comprising a gravitation sensor, machine-readable instructions, and programmable circuitry to execute the machine-readable instructions to determine an initial value of a load pitch angle of the vehicle when the vehicle is stationary based on output from the gravitation sensor of the vehicle, determine a change in the load pitch angle, determine a correction parameter of the vehicle based on a chassis behavior of the vehicle, determine a current value of the load pitch angle based on the initial value of the load pitch angle, the change in the load pitch angle, and the correction parameter, and adjust a position of a headlamp of the vehicle based on the current value of the load pitch angle.

Example 18 includes the apparatus of example 17, wherein the current value of the load pitch angle is determined in response to starting the vehicle.

Example 19 includes the apparatus of example 17, wherein the current value of the load pitch angle is further based on a comparison of the change in the load pitch angle and the initial value of the load pitch angle.

Example 20 includes the apparatus of example 17, wherein the correction parameter includes at least one of a correction value, a correction factor, a mathematical correction function, a correction value lookup table, or a correction value curve.

What is claimed is:

1. A method for adjustment of a headlamp of a vehicle, the method comprising:
determining an initial value of a load pitch angle of the vehicle based on output from a gravitation sensor of the vehicle when the vehicle is stationary;
determining a change in the load pitch angle;
determining a correction parameter of the vehicle based on a chassis behavior of the vehicle;
determining a current value of the load pitch angle based on the initial value of the load pitch angle, the change in the load pitch angle, and the correction parameter; and
adjusting the headlamp based on the current value of the load pitch angle.

2. The method according to claim 1, wherein the current value of the load pitch angle is determined in response to starting the vehicle.

3. The method according to claim 1, wherein the current value of the load pitch angle is determined further based on a comparison of the change in the load pitch angle and the initial value of the load pitch angle.

4. The method according to claim 1, wherein the correction parameter includes at least one of a correction value, a correction factor, a mathematical correction function, a correction value lookup table, or a correction value curve.

5. The method according to claim 1, wherein the correction parameter corresponds to the change in the load pitch angle relative to the initial value of the load pitch angle.

6. The method according to claim 5, wherein the correction parameter is expressed as at least one of a factor, a percentage uplift, or a functional dependence.

7. The method according to claim 1, wherein the correction parameter is determined based on characteristics of at least one of a chassis, a wheel suspension, springs, or vibration damping of the vehicle.

8. The method according to claim 1, including:
determining a setting position of the headlamp,
determining a deviation of the current value of the load pitch angle from the setting position and a resulting deviation of the headlamp from the setting position, and
adjusting the setting position of the headlamp based on the deviation.

9. A non-transitory machine readable storage medium comprising instructions to cause programmable circuitry to at least:
determine an initial value of a load pitch angle of a vehicle based on output from a gravitation sensor of the vehicle when the vehicle is stationary;
determine a change in the load pitch angle;
determine a correction parameter of the vehicle based on a chassis behavior of the vehicle;
determine a current value of the load pitch angle based on the initial value of the load pitch angle, the change in the load pitch angle, and the correction parameter; and
control a movement of a headlamp of the vehicle based on the current value of the load pitch angle.

10. The non-transitory machine readable storage medium of claim 9, wherein the current value of the load pitch angle is determined in response to determining that the vehicle has been started.

11. The non-transitory machine readable storage medium of claim 9, wherein the current value of the load pitch angle is determined further based on a comparison of the change in the load pitch angle and the initial value of the pitch angle.

12. The non-transitory machine readable storage medium of claim 9, wherein the correction parameter includes at least one of a correction value, a correction factor, a mathematical correction function, a correction value lookup table, or a correction value curve.

13. The non-transitory machine readable storage medium of claim 9, wherein the correction parameter corresponds to the change in the load pitch angle relative to the initial value of the load pitch angle.

14. The non-transitory machine readable storage medium of claim 13, wherein the correction parameter is expressed as at least one of a factor, a percentage uplift, or a functional dependence.

15. The non-transitory machine readable storage medium of claim 9, wherein the correction parameter is determined based on characteristics of at least one of a chassis, a wheel suspension, springs, or vibration damping of the vehicle.

16. The non-transitory machine readable storage medium of claim 9, wherein the instructions cause the programmable circuitry to:
determine a setting position of the headlamp,
determine a deviation of the current value of the load pitch angle from the setting position and a resulting deviation of headlamp from the setting position, and
adjust the setting position of the headlamp based on the deviation.

17. An apparatus for headlamp adjustment of a vehicle, the apparatus comprising:
a gravitation sensor;
machine-readable instructions; and
programmable circuitry to execute the machine-readable instructions to:
determine an initial value of a load pitch angle of the vehicle when the vehicle is stationary based on output from the gravitation sensor of the vehicle;
determine a change in the load pitch angle;
determine a correction parameter of the vehicle based on a chassis behavior of the vehicle;
determine a current value of the load pitch angle based on the initial value of the load pitch angle, the change in the load pitch angle, and the correction parameter; and
adjust a position of a headlamp of the vehicle based on the current value of the load pitch angle.

18. The apparatus of claim 17, wherein the current value of the load pitch angle is determined in response to starting the vehicle.

19. The apparatus of claim 17, wherein the current value of the load pitch angle is further based on a comparison of the change in the load pitch angle and the initial value of the load pitch angle.

20. The apparatus of claim 17, wherein the correction parameter includes at least one of a correction value, a correction factor, a mathematical correction function, a correction value lookup table, or a correction value curve.
